(19) United States
(12) Patent Application Publication
(10) Pub. No.: US 2023/0044808 A1
(43) Pub. Date: Feb. 9, 2023

(54) FUEL-CELL GAS DIFFUSION ASSEMBLY, MEMBRANE-ELECTRODE ASSEMBLY, AND ARRANGEMENT

(71) Applicant: Carl Freudenberg KG, Weinheim (DE)

(72) Inventors: Juergen Emig, Grasellenbach (DE); Jan Kemmerich, Weinheim (DE); Christian Quick, Weinheim (DE)

(21) Appl. No.: 17/879,817

(22) Filed: Aug. 3, 2022

(30) Foreign Application Priority Data
Aug. 3, 2021 (DE) 10 2021 120 110.1

(51) Int. Cl. H01M 8/0273; H01M 8/1004; H01M 8/0286

(52) U.S. Cl. CPC H01M 8/0273; H01M 8/1004; H01M 8/0286

(57) ABSTRACT

A gas diffusion assembly for a fuel cell includes: a sheetlike gas diffusion layer disposed on a carrier substrate, a sealing arrangement being disposed on at least one main side of the carrier substrate, and a connecting portion of the sealing arrangement being assigned to a surrounding edge of the gas diffusion layer, the connecting portion forming a sealing bead. The connecting portion fastens the gas diffusion layer with material bonding on the carrier substrate.

### CROSS-REFERENCE TO PRIOR APPLICATION

Priority is claimed to German Patent Application No. DE 10 2021 120 110.1, filed on Aug. 3, 2021, the entire disclosure of which is hereby incorporated by reference herein.

### FIELD

The invention relates to a gas diffusion assembly for a fuel cell, comprising a sheetlike gas diffusion layer disposed on a carrier substrate, where on at least one main side of the carrier substrate a sealing arrangement is disposed, where a connecting portion of the sealing arrangement is assigned to the surrounding edge of the gas diffusion assembly, where the connecting portion forms a sealing bead. Gas diffusion assemblies of the aforementioned kind are employed not only in fuel cells but also in comparable applications, such as in electrolyzers or redox flow batteries.

### BACKGROUND

Fuel cells, which generate electrical energy by oxidation of a fuel, consist usually of multiple electrically conducting electrodes which are arranged one above another in stacks, are gas-permeable, and are separated from one another by an ion-conducting membrane. Reaction media are supplied via bipolar plates provided with fluid channels, and additionally a cooling medium may be passed through the bipolar plates which carries off heat of reaction. For targeted guiding of the reaction media and cooling media it is necessary in such a system to seal off the distributing structures and channels.

From EP 1 320 142 B1 it is known practice, for example, to provide a sealing element which is disposed between two bipolar plates and which seals off the bipolar plates and the gas diffusion layers disposed between the bipolar plates, with the membrane, such that the reaction media are in contact with one another via the membrane and that the cooling media flow in the channels intended for them.

A fuel cell stack element comprises usually two bipolar plates with a membrane-electrode arrangement disposed between them. A membrane-electrode arrangement in turn comprises two gas diffusion layers, between which there is a catalyst-coated membrane, or two gas diffusion electrodes with the membrane between them. A fuel cell stack may comprise more than 200 arrangements, each comprising two bipolar plates and one membrane-electrode arrangement. For high functionality it is necessary for the components of the arrangement to be mounted with correct positioning relative to one another, the aim being to prevent reaction media leakage. The reaction media are to react with one another exclusively in the region of the gas diffusion layers and the catalyst-coated membrane.

### SUMMARY

In an embodiment, the present invention provides a gas diffusion assembly for a fuel cell, comprising: a sheetlike gas diffusion layer disposed on a carrier substrate, a sealing arrangement being disposed on at least one main side of the carrier substrate, and a connecting portion of the sealing arrangement being assigned to a surrounding edge of the gas diffusion layer, the connecting portion forming a sealing bead, wherein the connecting portion fastens the gas diffusion layer with material bonding on the carrier substrate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a gas diffusion assembly with carrier substrate in plan view;

FIG. 2 shows a further gas diffusion layer;

FIG. 3 shows a membrane-electrode assembly in section; and

FIG. 4 shows an arrangement with bipolar plates and membrane-electrode assembly in an exploded representation.

### DETAILED DESCRIPTION

In an embodiment, the present invention develops the arrangement such that assembly is simplified.

The gas diffusion assembly of the invention for a fuel cell comprises a sheetlike gas diffusion layer disposed on a carrier substrate, where on at least one main side of the carrier substrate a sealing arrangement is disposed, where a connecting portion of the sealing arrangement is assigned to the surrounding edge of the gas diffusion layer, where the connecting portion forms a sealing bead, where the connecting portion fastens the gas diffusion layer with material bonding on the carrier substrate.

The carrier substrate is provided with a sealing arrangement disposed on one or, preferably, on both main sides of the carrier substrate. This sealing arrangement may bring about sealing relative to the bipolar plates. Because the sealing arrangement is applied on a carrier substrate, it is particularly simple to position the sealing arrangement between the bipolar plates. In this case, for example, there is no need to mount a separate seal manually on the bipolar plates, an operation which has to date entailed a particularly high level of manual manufacturing effort. Because the sealing arrangement is disposed on a carrier substrate, the sealing arrangement is dimensionally stable and can be assigned to a bipolar plate with correct positioning in a particularly simple way.

In the refinement of the invention the gas diffusion layer is fastened with material bonding on the carrier substrate. This is done through a region of the sealing arrangement that forms a connecting portion. The connecting portion on the one hand forms a sealing bead, via which sealing relative to bordering components can be achieved; on the other hand, the connecting portion connects gas diffusion layer with carrier substrate. This results in an anti-loss material bond connecting gas diffusion layer and carrier substrate with one another. A particular advantage of this connection is that the gas diffusion layer is fastened with correct positioning on the carrier substrate, and so the assembly of the membrane—for example, of a catalyst-coated polymer electrolyte membrane (CCM)—within the arrangement is particularly simple.

To produce a gas diffusion assembly, a carrier substrate can be provided on which a gas diffusion layer is disposed. The sealing arrangement is subsequently applied to the carrier substrate, with the sealing material in the region of the edge of the gas diffusion layer forming a connecting portion by which the gas diffusion layer is bonded materially to the carrier substrate. This sealing material is preferably shaped such that at least one sealing bead is formed.

The carrier substrate is preferably configured as a film, where there are apertures in the film. The film configuration makes the carrier substrate particularly thin. The apertures enable unhindered transport of reaction media and of cooling media as well through the carrier substrate. An aperture is made in particular in that region of the carrier substrate in which the gas diffusion layer is disposed. As a result, unhindered transport of reaction medium in membrane direction is possible.

There is preferably a sealing arrangement disposed on both main sides of the carrier substrate. With this refinement only a single carrier substrate is needed between two bipolar plates. On both main sides of the carrier substrate there is a sealing arrangement, each of which comes to abutment on a bordering bipolar plate.

The sealing arrangement may comprise sealing beads which surround apertures and/or are assigned to the edge of the carrier substrate. Reaction media are passed through first apertures, and cooling media through second apertures. Because the sealing beads surround the apertures, leakages can be avoided. A sealing arrangement assigned to the edge of the carrier substrate seals off the arrangement with two bipolar plates in the region of the edges.

The carrier substrate may be configured of thermoplastics. One advantageous material for the carrier substrate in this case is polyethylene naphthalate (PEN). PEN is a thermoplastic from the polyester family which is produced by polycondensation. PEN is highly gastight and has high heat distortion resistance and a high chemical and hydrolytic stability. Accordingly PEN is suitable especially for use in fuel cells.

The sealing arrangement is preferably configured of injection-moldable elastomeric material. With this refinement, the sealing arrangement may be applied, for example, in the course of the injection molding operation. It is conceivable in particular in this case for the sealing material to be selected from the group of polyolefin elastomers, fluoro elastomers, and silicone elastomers.

A membrane-electrode assembly of the invention for a fuel cell comprises a gas diffusion assembly, a further gas diffusion layer, and a catalyst-coated membrane disposed between gas diffusion assembly and further gas diffusion layer, where the further gas diffusion layer is provided along the surrounding edge with a further sealing bead, where the catalyst-coated membrane is disposed between gas diffusion assembly and further gas diffusion layer, and where the sealing bead of the connecting portion and the further sealing bead of the gas diffusion layer sealingly abut the membrane.

To produce the membrane-electrode assembly, first a gas diffusion assembly with carrier substrate and gas diffusion layer is provided, the gas diffusion layer being materially bonded to the carrier substrate. The catalyst-coated membrane is disposed on the gas diffusion layer such that the connecting portion comes to abutment sealingly at the edges of the catalyst-coated membrane. A further gas diffusion layer covers the catalyst-coated membrane, and the further gas diffusion layer has a further sealing bead, which likewise comes to abutment on the catalyst-coated membrane and, on the side opposite the gas diffusion assembly, seals off the membrane in the region of the edges. Because the gas diffusion layer of the gas diffusion assembly is fastened on a carrier substrate, it is particularly simple to produce the membrane-electrode assembly. In particular there is no need to fasten the catalyst-coated membrane in the membrane-electrode assembly. Because of the sealing bead of the two gas diffusion layers, the membrane is sealed off and fastened with correct positioning in the region of the edges. It is therefore not necessary either for the catalyst-coated membrane to be materially bonded to one or both gas diffusion layers. The catalyst-coated membrane can just be inserted loosely between the gas diffusion layers.

The gas diffusion layer and the further gas diffusion layer preferably comprise a matrix of fibrous material. Fibrous materials are, for example, woven fabrics, papers, and nonwovens. Nonwovens are preferred here, as they are inexpensive to produce and have high permeability to reaction media. Nonwovens, furthermore, can be equipped with electrical conductivity.

An arrangement of the invention for a fuel cell comprises a membrane-electrode assembly of the invention disposed between two bipolar plates, where the bipolar plates in the regions assigned to the gas diffusion layers have a distributing structure and where there are media transport channels in the bipolar plates.

Preferably a sealing arrangement is disposed on both main sides of the carrier substrate and to seal the channels comes to abutment on the bipolar plates. Accordingly the carrier substrate, with the sealing arrangements disposed on both main sides, brings about sealing between the bipolar plates and prevents leakages of reaction media or cooling media.

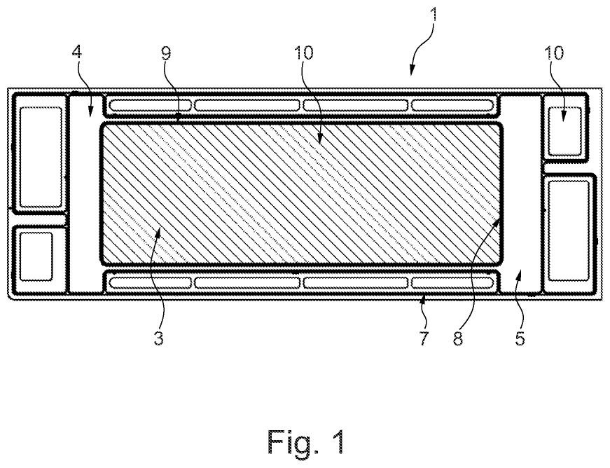

FIG. 1 in the plan view shows a gas diffusion assembly 1 for a fuel cell. The gas diffusion assembly 1 comprises a sheetlike gas diffusion layer 3, consisting of an electrically conductive nonwoven. The gas diffusion layer 3 is disposed on a carrier substrate 4. The carrier substrate 4 is configured as a film and in the present refinement consists of polyethylene naphthalate (PEN). There are apertures 10 in the film.

Mounted respectively on both main sides 5, 6 of the carrier substrate 4 is a sealing arrangement 7. On one main side 5 this sealing arrangement 7 forms a connecting portion 8, where the connecting portion is assigned to the surrounding edge 9 of the gas diffusion layer 3. The connecting portion 8 accordingly forms a sealing bead and fastens the gas diffusion layer 3 with material bonding on the carrier substrate 4.

The carrier substrate 4 comprises an aperture 10 which is assigned to the gas diffusion layer 3 and serves to transport transport media through the gas diffusion layer 3. The carrier substrate 4 comprises further apertures 10, which serve to transport cooling media through the carrier substrate 4. The sealing arrangement 7 comprises a sealing bead which surrounds the apertures 10. A further sealing bead is assigned to the edge of the carrier substrate 4. The sealing arrangement 7 is configured of injection-moldable elastomeric material. In this refinement the sealing arrangement 7 consists of a polyolefin elastomer.

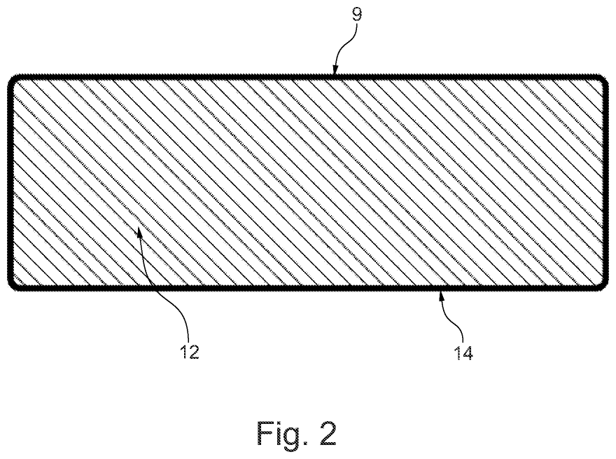

FIG. 2 shows a further gas diffusion layer 12. The further gas diffusion layer 12 consists of a sheetlike nonwoven equipped with electrical conductivity, and is provided along the surrounding edge 9 with a further sealing bead 14.

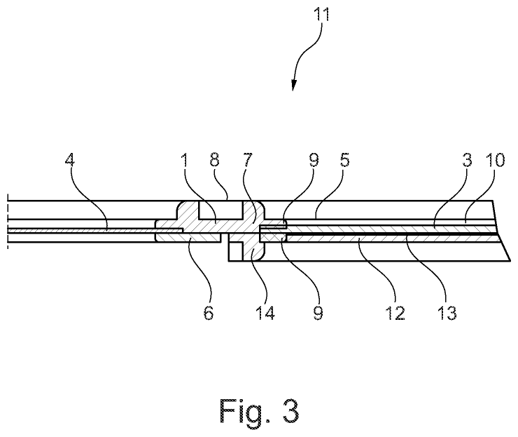

FIG. 3 shows a membrane-electrode assembly 11 for a fuel cell, comprising a gas diffusion assembly 1 as in FIG. 1, and a further gas diffusion layer 12 according to FIG. 2. Disposed between the gas diffusion assembly 1 and the further gas diffusion layer 12 is a membrane 13 coated with a catalyst. The sealing bead of the connecting portion 8 of the sealing arrangement 7 of the gas diffusion assembly 1 and the further sealing bead 14 of the further gas diffusion layer 12 sealingly abut the catalyst-coated membrane 13. This catalyst-coated membrane 13 is held only force-fittingly between the gas diffusion assembly 1 and the gas diffusion layer 12.

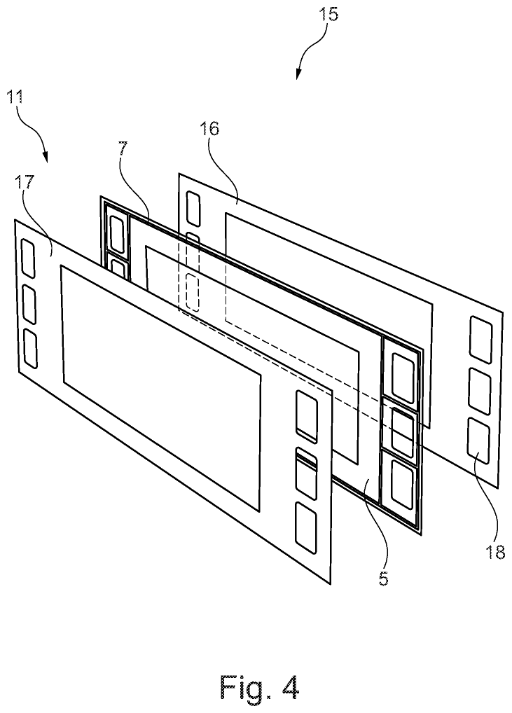

FIG. 4 shows an arrangement 15 for a fuel cell. The arrangement 15 comprises a membrane-electrode assembly 11 as in FIG. 3, which is disposed between two bipolar plates 16, 17. The bipolar plates 16, 17 are in a sheetlike configuration, composed of a graphite-containing material. Alternatively the bipolar plates 16, 17 may also be configured of a metallic material. In the regions assigned to the gas diffusion layers 3, 12, the bipolar plates 16, 17 have a distributing structure for the distribution of reaction medium. There are also channels 18 in the bipolar plates 16, 17 for transporting reaction media and cooling media.

The sealing arrangement 7 disposed on both main sides 5, 6 of the carrier substrate 4 to seal the channels 18 comes to abutment on the bipolar plates 16, 17.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A gas diffusion assembly for a fuel cell, comprising:
a sheetlike gas diffusion layer disposed on a carrier substrate, a sealing arrangement being disposed on at least one main side of the carrier substrate, and a connecting portion of the sealing arrangement being assigned to a surrounding edge of the gas diffusion layer, the connecting portion forming a sealing bead,
wherein the connecting portion fastens the gas diffusion layer with material bonding on the carrier substrate.

2. The gas diffusion assembly of claim 1, wherein the carrier substrate comprises a film,
wherein there are apertures in the film.

3. The gas diffusion assembly of claim 1, wherein a sealing arrangement is disposed on both main sides of the carrier substrate.

4. The gas diffusion assembly of claim 2, wherein the sealing arrangement comprises sealing beads which surround the apertures and/or are assigned to an edge of the carrier substrate.

5. The gas diffusion assembly of claim 1, wherein the carrier substrate comprises a thermoplastic material.

6. The gas diffusion assembly of claim 1, wherein the sealing arrangement comprises an injection-moldable elastomeric material.

7. A membrane-electrode assembly for a fuel cell, comprising:
the gas diffusion assembly of claim 1;
a further gas diffusion layer; and
a catalyst-coated membrane disposed between gas diffusion assembly and further gas diffusion layer,
wherein the further gas diffusion layer is provided along the surrounding edge with a further sealing bead, and
wherein the sealing bead of the connecting portion and the further sealing bead sealingly abut the catalyst-coated membrane.

8. The membrane-electrode assembly of claim 7, wherein the gas diffusion layers comprise a matrix of fibrous material.

9. An arrangement for a fuel cell, comprising:
the membrane-electrode assembly of claim 7, the membrane-electrode assembly being disposed between two bipolar plates,
wherein the bipolar plates in regions assigned to the gas diffusion layers have a distributing structure, and
wherein there are transport channels in the bipolar plates.

10. The arrangement of claim 9, wherein a sealing arrangement is disposed on both main sides of the carrier substrate, and
wherein to seal the channels, the sealing arrangement comes to abutment on the bipolar plates.
